(19) United States
(12) Patent Application Publication
(10) Pub. No.: US 2025/0333006 A1
(43) Pub. Date: Oct. 30, 2025

(54) EXTENDED HOOK STRUCTURE FOR ROOF CROSSBAR

(71) Applicant: Guangzhou Issyzone Technology Co.,Limited, Guangzhou (CN)

(72) Inventors: TAIPING YANG, Guangzhou City (CN); CHAO YU, Guangzhou City (CN); GUOCHAO XU, Guangzhou City (CN)

(21) Appl. No.: 19/031,524

(22) Filed: Jan. 18, 2025

(30) Foreign Application Priority Data
Apr. 24, 2024 (CN) 202420858787.4

(51) Int. Cl. B60R 9/052; B60R 9/045

(52) U.S. Cl. CPC B60R 9/052; B60R 9/045

(57) ABSTRACT

The invention discloses an extended hook structure for a roof crossbar. The extended hook structure for a roof crossbar includes: a first webbing configured to be fixed to a roof crossbar. Both ends of the first webbing are provided with an adjustable hook assembly and a second hook configured to be hitched to a door frame of a target vehicle, respectively. The adjustable hook assembly includes a lock catch configured to be connected to one end of the first webbing, the other end of the lock catch is connected to a second webbing, and a tip end of the second webbing is provided with a first hook configured to be hitched to a door frame of the target vehicle. The present utility model has the following beneficial effects. This hook structure is adapted to a vehicle model without a luggage rack, which increases an application range of the roof crossbar.

### CROSS REFERENCE TO RELATED APPLICATIONS

The present application claims the priority of Chinese patent application No. 202420858787.4, filed on Apr. 24, 2024, and contents of which are incorporated herein by reference.

### BACKGROUND OF THE INVENTION

### Field of the Invention

The present utility model relates to the technical field of automobile accessories, in particular to an extended hook structure for a roof crossbar.

### Description of Related Art

For an SUV model, a luggage rack (longitudinal rail) is usually mounted on a roof of the vehicle previously, an accessory manufacturer manufactures a special roof luggage box based on a size and a structure of the luggage rack, and a user can directly mount a roof luggage box purchased by himself or herself on the luggage rack when using the luggage rack and the roof luggage box. However, the special roof luggage box is not universal, and since a mold making cost is expensive, this part of the cost will eventually be passed on to the user, resulting in low compatibility and cost-effectiveness of the special roof luggage box. Therefore, the user is increasingly inclined to choose a universal roof crossbar (cross rail). Chinese utility model patent CN219728038U discloses a roof crossbar assembly and a roof crossbar, which provides a solution of a crossbar body obtained by processing a rigid rubber plastic foam in view of a problem that the existing roof crossbar is easy to scrape a luggage rack.

However, a mounting method of the above-mentioned roof crossbar still requires cooperation of the luggage rack. This is because when the roof crossbar is in use, both ends of a webbing need to be connected end to end to provide a reliable annular connection relation for the crossbar body. Obviously, the both ends of the webbing need to pass under the luggage rack when being fixed. For a vehicle model without a luggage rack (such as a sedan), this product cannot be used. If the both ends of the above-mentioned webbing are forcibly passed through a car compartment and connected end to end, the webbing may be exposed inside the car compartment and hit a head of a passenger. This is not a reasonable design.

In summary, compared with the special roof luggage box, the roof crossbar obtained by processing the rigid rubber plastic foam is indeed a more convenient and universal alternative product, but such a roof crossbar cannot be adapted to a vehicle model without a luggage rack, such as a sedan, which limits an application scope of the roof crossbar.

### SUMMARY OF THE INVENTION

In view of the above-mentioned problem, the present utility model provides an extended hook structure for a roof crossbar, which mainly solves the problem that the existing roof crossbar cannot be adapted to a vehicle model without a luggage rack.

In order to solve the above-mentioned technical problems, technical solutions of the present utility model are as follows.

An extended hook structure for a roof crossbar includes: a first webbing configured to be fixed to a roof crossbar. Both ends of the first webbing are provided with an adjustable hook assembly and a second hook configured to be hitched to a door frame of a target vehicle, respectively. The adjustable hook assembly includes a lock catch configured to be connected to one end of the first webbing, the other end of the lock catch is connected to a second webbing, and a tip end of the second webbing is provided with a first hook configured to be hitched to a door frame of the target vehicle.

In some embodiments, the lock catch includes a fixing member and a buckle hingedly mounted inside the fixing member, a channel is formed between the buckle and a side wall of the fixing member, and the one end of the first webbing is configured to enter from below the channel and pass out from above the channel.

In some embodiments, the buckle includes a hinge member mounted inside the fixing member, an unlocking block and a clamping block that are diverged by an obtuse angle are radially provided on an outer surface of the hinge member, a space between the clamping block and the side wall of the fixing member is defined as the channel, and a width of the channel is less than a thickness of the first webbing.

In some embodiments, the adjustable hook assembly further includes a third webbing, both ends of the third webbing are configured to be connected to the first webbing and the second webbing, respectively, and the third webbing is located directly below the lock catch.

In some embodiments, a fixing groove is formed in a middle portion of the third webbing, and before the first webbing is connected to the lock catch, the one end of the first webbing is configured to enter from below the fixing groove and pass out from above the fixing groove sequentially.

In some embodiments, the second hook and/or the first hook are configured to be detached.

The present utility model has the following beneficial effects. During use, first, the roof crossbar with the first webbing passed therethrough is placed on a roof of the target vehicle, and the second hook and the first hook are hitched to the two door frames of the target vehicle, respectively, and by adjusting a length of the first webbing and fixing the first webbing with the adjustable hook assembly, the roof crossbar can be fixed on the roof of the target vehicle. This hook structure is adapted to a vehicle model without a luggage rack, which increases an application range of the roof crossbar.

### BRIEF DESCRIPTION OF THE DRAWINGS

FIG. 1 is a perspective view of an extended hook structure for a roof crossbar disclosed in an embodiment of the present utility model.

FIG. 2 is a schematic diagram showing mounting of the extended hook structure for a roof crossbar disclosed in the embodiment of the present utility model.

FIG. 3 is a partially enlarged view of a lock catch disclosed in the embodiment of the present utility model.

FIG. 4 is a partially enlarged view of a buckle disclosed in the embodiment of the present utility model.

FIG. 5 is a schematic diagram showing mounting of a third webbing disclosed in the embodiment of the present utility model.

### REFERENCE SIGNS LIST

1: first webbing, 2: adjustable hook assembly, 3: second hook, 4: first hook, 21: lock catch, 22: second webbing, 23: third webbing, 211: fixing member, 212: buckle, 213: channel, 231: fixing groove, 2121: hinge member, 2122: unlocking block, 2123: clamping block, 100: roof crossbar, 200: door frame.

### DETAILED DESCRIPTION OF THE INVENTION

In order to make an object, technical solutions, and advantages of the present utility model clearer and more specific, the content of the present utility model is further described in detail with reference to the drawings and detailed description. It is understandable that the specific embodiment described here is merely used to describe the present utility model, not to limit the present utility model. It should be noted that, for the convenience of description, only parts related to the present utility model are shown in the drawings, not all of the contents.

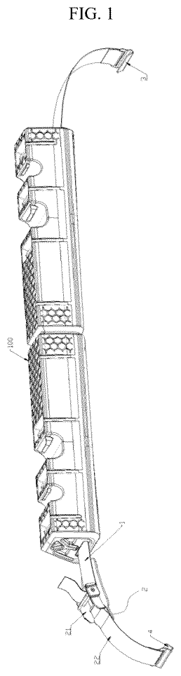

The present embodiment provides an extended hook structure for a roof crossbar. As shown in FIG. 1, the extended hook structure for a roof crossbar includes: a first webbing 1 configured to be fixed to a roof crossbar 100. Both ends of the first webbing 1 are provided with an adjustable hook assembly 2 and a second hook 3 configured to be hitched to a door frame of a target vehicle, respectively, the adjustable hook assembly 2 includes a lock catch 21 configured to be connected to one end of the first webbing 1, the other end of the lock catch 21 is connected to a second webbing 22, and a tip end of the second webbing 22 is provided with a first hook 4 configured to be hitched to a door frame of the target vehicle.

In the present embodiment, during use, first, the roof crossbar 100 with the first webbing 1 passed therethrough is placed on a roof of the target vehicle, and the second hook 3 and the first hook 4 are hitched to the two door frames of the target vehicle, respectively, and by adjusting a length of the first webbing 1 and fixing the first webbing 1 with the adjustable hook assembly 2, the roof crossbar 100 can be fixed on the roof of the target vehicle. This hook structure is adapted to a vehicle model without a luggage rack, which increases an application range of the roof crossbar.

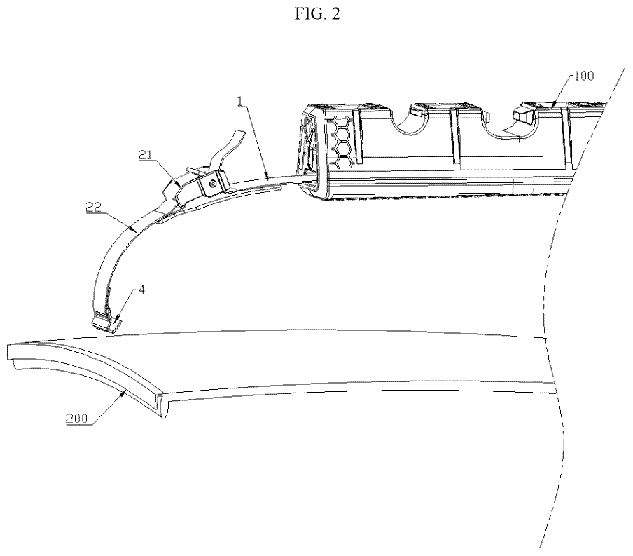

It should be noted that, in the present embodiment, the door frame of the target vehicle may be a door frame of any mass-produced SUV model or sedan model. The outside of the door frame is covered with a sealing strip (not shown in the figure), and therefore, it is necessary to pull the sealing strip open first to expose a top edge of the door frame, so as to hitch the first hook 4/second hook 3 to the edge of the door frame 200, as shown in FIG. 2. After the first hook 4/second hook 3 is mounted, the sealing strip is fastened to the top edge of the door frame.

Obviously, when the adjustable hook assembly 2 and the second hook 3 are mounted on the both ends of the first webbing 1 previously, the first webbing 1 will not be able to pass through the roof crossbar 100. Therefore, this structure can be mounted on the roof crossbar 100 previously as an assembly. In order to improve flexibility of the product, the second hook 3 and/or the first hook 4 configured to be detached. When a user needs to replace the first webbing 1, the user can detach one or both of the second hook 3 and the first hook 4 by himself or herself to provide a basis for the first webbing 1 to exit the roof crossbar 100.

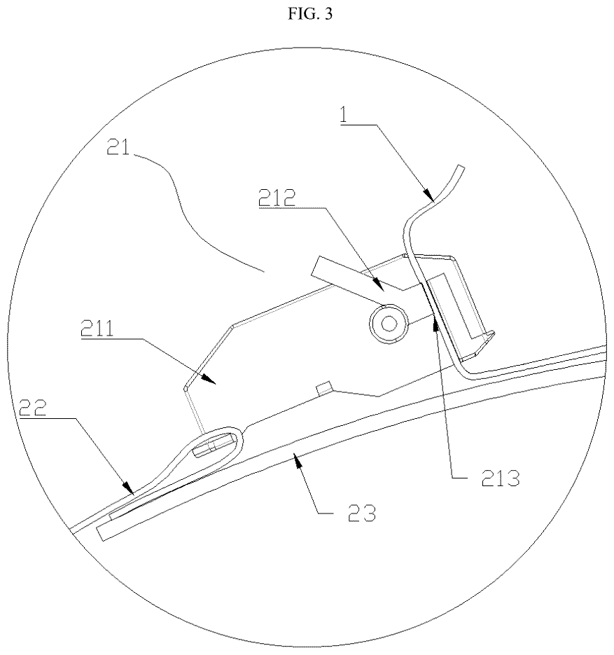

The above-mentioned lock catch 21 can be any locking member that can fix the first webbing 1. As shown in FIG. 3, the lock catch 21 includes a fixing member 211 and a buckle 212 hingedly mounted inside the fixing member 211, a channel 213 is formed between the buckle 212 and a side wall of the fixing member 211, and the channel 213 is used to accommodate the first webbing 1. When adjusting a tightness of the first webbing 1, the user needs to cause the one end of the first webbing 1 to enter from below the channel 213 and pass out from above the channel 213, and needs to pull the first webbing 1 upward to ensure that the first webbing 1 is straightened, and finally uses the buckle 212 to fix the first webbing 1.

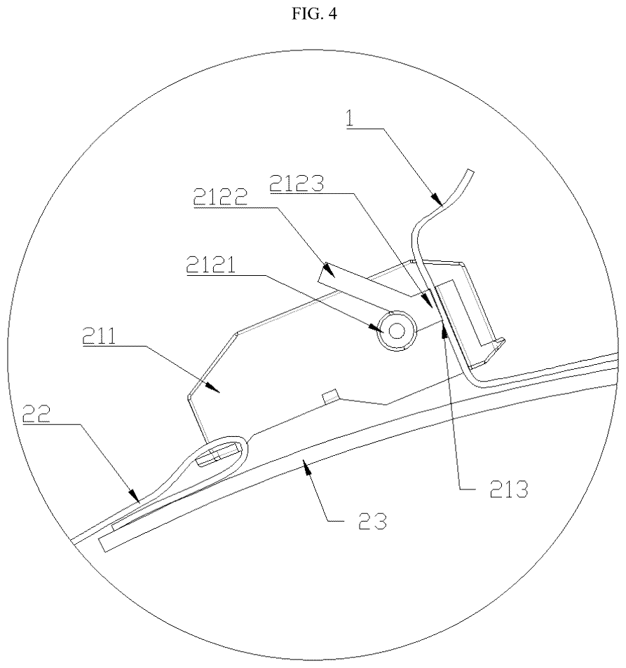

In order to improve reliability of the lock catch 21, a preferred solution is provided in the present embodiment to ensure that the first webbing 1 will not get loose during use. Specifically, as shown in FIG. 4, the buckle 212 includes a hinge member 2121 mounted inside the fixing member 211, an unlocking block 2122 and a clamping block 2123 that are diverged by an obtuse angle are radially provided on an outer surface of the hinge member 2121, a space between the clamping block 2123 and the side wall of the fixing member 211 is defined as the channel 213, and a width of the channel 213 is less than a thickness of the first webbing 1. In this solution, when the tightness of the first webbing 1 needs to be adjusted, the user needs to first toggle the unlocking block 2122 to a direction of the roof crossbar 100, at this time, the clamping block 2123 rotates clockwise synchronously, and a width of the channel 213 increases. Therefore, the end of the first webbing 1 can smoothly enter the channel 213. Then the unlocking block 2122 is toggled reversely immediately, and the clamping block 2123 rotates counterclockwise synchronously to clamp the first webbing 1, thereby forming effective fixation by interference clamping. More importantly, after the clamping block 2123 clamps the first webbing 1, no matter the first webbing 1 is subjected to external vibration or the user actively tears the first webbing 1 downward, the first webbing 1 will not get loose, and will be clamped more and more tightly by the clamping block 2123, which is similar to an effect of a ratchet.

Optionally, still referring to FIG. 3, the adjustable hook assembly 2 further includes a third webbing 23, both ends of the third webbing 23 are configured to be connected to the first webbing 1 and the second webbing 22, respectively, and the third webbing 23 is located directly below the lock catch 21. The third webbing 23 has two functions. The first function is to isolate the lock catch 21 from a roof paint to prevent the lock catch 21 from scratching the paint, and the second function is to increase a connection strength between the first webbing 1 and the second webbing 22.

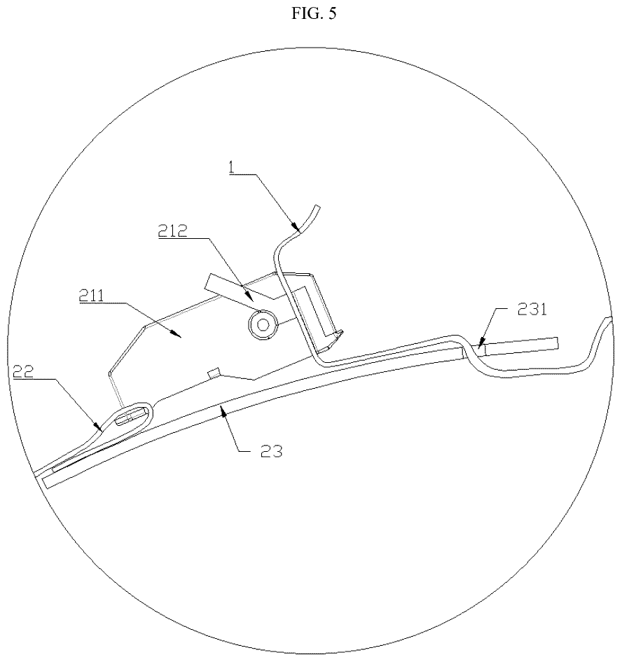

Further, as shown in FIG. 5, a fixing groove 231 is formed in a middle portion of the third webbing 23, and before the first webbing 1 is connected to the lock catch 21, the one end of the first webbing 1 is configured to enter from below the fixing groove 231 and pass out from above the fixing groove 231 sequentially. This arrangement can limit a mounting position of the first webbing 1 and prevent the first webbing 1 from shaking left and right.

The above-mentioned embodiment merely describes the technical concept and characteristics of the present utility model, and an object thereof is to enable those skilled in the art to understand the content of the present utility model and implement the same, and does not limit the protection scope of the present utility model. Any equivalent changes or modifications made according to the substance of the content of the present utility model should be included in the protection scope of the present utility model.

The present utility model discloses an extended hook structure for a roof crossbar. The extended hook structure for a roof crossbar includes: a first webbing configured to be fixed to a roof crossbar. Both ends of the first webbing are provided with an adjustable hook assembly and a second hook configured to be hitched to a door frame of a target vehicle, respectively. The adjustable hook assembly includes a lock catch configured to be connected to one end of the first webbing, the other end of the lock catch is connected to a second webbing, and a tip end of the second webbing is provided with a first hook configured to be hitched to a door frame of the target vehicle. The present utility model has the following beneficial effects. During use, first, the roof crossbar with the first webbing passed therethrough is placed on a roof of the target vehicle, and the second hook and the first hook are hitched to the two door frames of the target vehicle, respectively, and by adjusting a length of the first webbing and fixing the first webbing with the adjustable hook assembly, the roof crossbar can be fixed on the roof of the target vehicle. This hook structure is adapted to a vehicle model without a luggage rack, which increases an application range of the roof crossbar.

What is claimed is:

1. An extended hook structure for a roof crossbar, comprising: a first webbing configured to be fixed to a roof crossbar, wherein both ends of the first webbing are provided with an adjustable hook assembly and a second hook configured to be hitched to a door frame of a target vehicle, respectively, the adjustable hook assembly includes a lock catch configured to be connected to one end of the first webbing, the other end of the lock catch is connected to a second webbing, and a tip end of the second webbing is provided with a first hook configured to be hitched to a door frame of the target vehicle.

2. The extended hook structure for a roof crossbar according to claim 1, wherein the lock catch includes a fixing member and a buckle hingedly mounted inside the fixing member, a channel is formed between the buckle and a side wall of the fixing member, and the one end of the first webbing is configured to enter from below the channel and pass out from above the channel.

3. The extended hook structure for a roof crossbar according to claim 2, wherein the buckle includes a hinge member mounted inside the fixing member, an unlocking block and a clamping block that are diverged by an obtuse angle are radially provided on an outer surface of the hinge member, a space between the clamping block and the side wall of the fixing member is defined as the channel, and a width of the channel is less than a thickness of the first webbing.

4. The extended hook structure for a roof crossbar according to claim 1, wherein the adjustable hook assembly further includes a third webbing, both ends of the third webbing are configured to be connected to the first webbing and the second webbing, respectively, and the third webbing is located directly below the lock catch.

5. The extended hook structure for a roof crossbar according to claim 4, wherein a fixing groove is formed in a middle portion of the third webbing, and before the first webbing is connected to the lock catch, the one end of the first webbing is configured to enter from below the fixing groove and pass out from above the fixing groove sequentially.

6. The extended hook structure for a roof crossbar according to claim 1, wherein the second hook and/or the first hook are configured to be detached.
